(19) United States
(12) Patent Application Publication
(10) Pub. No.: US 2021/0208595 A1
(43) Pub. Date: Jul. 8, 2021

(54) USER RECOGNITION-BASED STROLLER ROBOT AND METHOD FOR CONTROLLING THE SAME

(71) Applicant: LG ELECTRONICS INC., Seoul (KR)

(72) Inventors: Hyongguk KIM, Seoul (KR); Jaeyoung KIM, Seoul (KR); Hyoungmi KIM, Seoul (KR); Yujune JANG, Seoul (KR)

(73) Assignee: LG ELECTRONICS INC., Seoul (KR)

(21) Appl. No.: 16/500,315

(22) PCT Filed: Jun. 18, 2019
(86) PCT No.: PCT/KR2019/007361

§ 371 Date: Oct. 2, 2019

(51) Int. Cl. G05D 1/02; G06K 9/00; G06F 3/16; B62B 9/10; B62B 9/12; B62B 9/24; G05D 1/00; G06N 20/00; G06N 5/04

(52) U.S. Cl. CPC G05D 1/0221; G06N 5/04; G06K 9/00342; G06F 3/16; G06K 9/00838; G06K 9/00375; G06K 9/00664; B62B 9/102; G05D 1/0231; G05D 1/0255; B62B 9/12; B62B 9/24; G05D 1/0055; G06N 20/00; G06K 9/00503

(57) ABSTRACT

The present invention relates to a user recognition-based stroller robot and a method for controlling the same, and more particularly, to a technology for detecting and controlling states of a guardian and an infant. The user recognition-based stroller robot comprises: a detection unit configured to recognize or measure at least one of a traveling state of the stroller robot or body structures of an infant inside the stroller robot and a guardian outside the stroller robot; a controller configured to determine whether the stroller robot is controlled according to the traveling state measured by the detection unit and determine a structure change of the stroller robot according to the body structure of at least one of the infant or the guardian; and a driving unit configured to adjust at least one of a display, a belt, a seat, or a handle installed in the stroller robot according to the determination of the controller. According to the present invention, the internal configuration is automatically adjusted through each sensor of the detection unit while the guardian and the infant use the stroller robot, thereby increasing convenience.

### FIELD

The present invention relates to a user recognition-based stroller robot and a method for controlling the same, and more particularly, to a technology for detecting and controlling states of a guardian and an infant.

### BACKGROUND

Generally, a stroller is a type of a moving means that an infant sits in and is pushed, and provides a moving function, a play tool function, and a sleep aid function in an infant's growth process. Accordingly, various kinds of functional strollers having consideration of the safety of the infant and the convenience of the guardian have been developed and are being sold in the market.

For example, Korean Patent Application Publication No. 2019-0063142 (Smart Stroller with Ball Caster) is disclosed. According to the related art, there is provided an automatic stroller in which a rear wheel is rotated according to a detection signal transmitted from a safety device, and a braking operation of the inside of the stroller is determined according to the state of the safety device, thereby providing convenient use.

However, according to the related art, although there is a convenience of manipulating or moving the stroller, there is a problem that the states of the guardian or the infant cannot be recognized to maintain an optimal boarding state.

### SUMMARY

The present invention is directed to provide a user recognition-based stroller robot that recognizes body structures of a guardian and an infant and adjusts a driving device inside the stroller robot.

The present invention is directed to provide a method for controlling a user recognition-based stroller robot that recognizes body structures of a guardian and an infant and controls a driving device inside the stroller robot.

According to the present invention, a user recognition-based stroller robot may include: a detection unit configured to recognize or measure at least one of a traveling state of the stroller robot or body structures of an infant inside the stroller robot and a guardian outside the stroller robot; a controller configured to determine whether the stroller robot is controlled according to the traveling state measured by the detection unit and determine a structure change of the stroller robot according to the body structure of at least one of the infant or the guardian; and a driving unit configured to adjust at least one of a display, a belt, a seat, or a handle installed in the stroller robot according to the determination of the controller.

In one embodiment, the user recognition-based stroller robot may further include: a camera configured to acquire image data including the body structure of the guardian or the infant; a microphone configured to acquire voice data including a voice of the guardian; and a controller configured to: acquire customer response data including at least one of the image data or the voice data through at least one of the camera or the microphone; estimate the body structure from the acquired customer response data; and generate or update customer management information about the body structure of the guardian or the infant based on the estimated response.

In one embodiment, the user recognition-based stroller robot may further include: a memory configured to store a learning model learned by a learning controller, wherein the controller is configured to estimate the body structure from the customer response data through the learning model stored in the memory.

In one embodiment, the user recognition-based stroller robot may further include: a communication unit configured to connect to a server, wherein the controller is configured to: control the communication unit to transmit the customer response data to the server; and receive, from the server, information about the body structure based on the customer response data.

In one embodiment, the detection unit may further include: a guardian detection sensor mounted on a front side of the stroller robot and configured to continuously collect a body image of the guardian and track a position of a specific body part; and an infant detection sensor mounted on an upper portion of the stroller robot and configured to continuously collect a body image of the infant and track a position of a specific body part.

In one embodiment, the detection unit may further include: an impact detection sensor connected to the seat and configured to detect a vibration or an impact amount appearing due to movement of the infant; and a defecation detection sensor configured to detect at least one of temperature, humidity, or specific chemical component of the seat.

The driving unit may further include: a seat driving module configured to adjust a position of the seat; and a belt driving module configured to adjust strength of the belt installed in the seat according to the body structure of the infant.

In one embodiment, the seat driving module may be configured to control shake or vibration of the seat.

The driving unit may further include an angle adjusting module configured to adjust a screen angle of the display by recognizing a gaze of the infant measured by the detection unit.

In one embodiment, the driving unit may further include a display module configured to display a control state of the controller on the display in an image form or notify a user of the control state of the controller in a voice form.

According to the present invention, a method for controlling a user recognition-based stroller robot may include: recognizing or measuring a traveling state of the stroller robot and body structures of an infant inside the stroller robot and a guardian outside the stroller robot; determining a structure change of the stroller robot according to the traveling state and the body structures; and adjusting at least one of a display, a belt, a seat, or a handle installed in the stroller robot.

In one embodiment, the method may further include: determining whether the traveling state is a stopped state; continuously collecting the body image of the guardian in a guardian detection sensor mounted on a front side of the stroller robot to track or measure a position of a hand of the guardian; and moving the handle of the stroller robot to the position of the hand of the guardian.

In one embodiment, the method may further include determining whether the hand of the guardian is in the handle of the stroller robot.

In one embodiment, the method may further include: recognizing the body structure of the infant and measuring whether the body structure is within a range of an accommodation space of the seat; and adjusting the structure of the seat so that the body structure of the infant matches the accommodation space of the seat.

In one embodiment, the method may further include: recognizing the body structure of the infant and measuring whether the body structure is within a range of an accommodation space of the belt; determining whether the belt and the body are formed within a reference space where safety of the infant is secured; and adjusting strength of the belt so that the body structure of the infant matches the accommodation space of the belt.

In one embodiment, the method may further include: recognizing the body structure of the infant and measuring whether a gaze of the infant is directed toward the display; and adjusting a screen angle of the display.

In one embodiment, the method may further include: allowing the guardian to switch to a shake mode or a vibration mode including strength and a cycle related to the shake or vibration of the seat; and controlling the shake or vibration of the seat according to the switching to the shake mode or the vibration mode

In one embodiment, the method may further include: detecting a vibration or an impact amount of the seat due to the movement of the infant; determining whether the vibration or the impact amount of the seat exceeds an average value; and lowering the height of the seat.

In one embodiment, the method may further include: detecting at least one of temperature, humidity, or specific chemical component of the seat through a defecation detection sensor installed in the seat; determining whether the measured value of the defecation detection sensor is different from an average value; and notifying the guardian through a display module.

In one embodiment, the method may further include, when the measured value of the defecation detection sensor is maintained for a preset time, notifying the guardian through the display module.

### BRIEF DESCRIPTION OF THE DRAWINGS

FIG. 1 illustrates an AI device including a robot according to an embodiment of the present invention.

FIG. 2 illustrates an AI server connected to a robot according to an embodiment of the present invention.

FIG. 3 illustrates an AI system including a robot according to an embodiment of the present invention.

FIG. 4 is a diagram illustrating a stroller robot together with a guardian according to an embodiment of the present invention.

FIG. 5 is a block diagram of the stroller robot illustrated in FIG. 1.

FIG. 6 is a flowchart of a method for controlling a stroller robot according to the present invention.

FIG. 7 is a diagram illustrating a state in which the heights of a seat and a handle of the stroller robot are automatically adjusted according to an embodiment of the present invention.

FIG. 8 is a flowchart illustrating the automatic adjustment of the position of the handle during stop of the stroller robot according to an embodiment of the present invention.

FIG. 9 illustrates a flowchart in which the position of the seat is automatically adjusted according to an embodiment of the present invention.

FIG. 10 illustrates a flowchart in which the structure of a belt is automatically adjusted according to an embodiment of the present invention.

FIG. 11 illustrates a flowchart in which an angle of a display is automatically adjusted according to an embodiment of the present invention.

FIG. 12 illustrates a flowchart in which the height of the seat is automatically adjusted according to the vibration or the impact amount of the seat, according to an embodiment of the present invention.

FIG. 13 illustrates a flowchart of the detection and notification of a defecation according to an embodiment of the present invention.

### DETAILED DESCRIPTION

Hereinafter, some embodiments of the present disclosure will be described in detail with reference to the accompanying drawings. It should be noted that when components in the drawings are designated by reference numerals, the same components have the same reference numerals as far as possible even though the components are illustrated in different drawings. Further, in description of embodiments of the present disclosure, when it is determined that detailed descriptions of well-known configurations or functions disturb understanding of the embodiments of the present disclosure, the detailed descriptions will be omitted.

Also, in the description of the embodiments of the present disclosure, the terms such as first, second, A, B, (a), and (b) may be used. Each of the terms is merely used to distinguish the corresponding component from other components, and does not delimit an essence, an order or a sequence of the corresponding component. It should be understood that when one component is “connected”, “coupled” or “joined” to another component, the former may be directly connected or jointed to the latter or may be “connected”, “coupled” or “joined” to the latter with a third component interposed therebetween.

Further, in describing the components of the embodiment of the present invention, the body structures of an guardian and an infant can be interpreted as body images.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, household robots, military robots, and the like according to the use purpose or field.

The robot includes a driving unit that includes an actuator or a motor and may perform various physical operations such as moving a robot joint. In addition, a movable robot may include a wheel, a brake, a propeller, and the like in a driving unit, and may travel on the ground through the driving unit or fly in the air.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

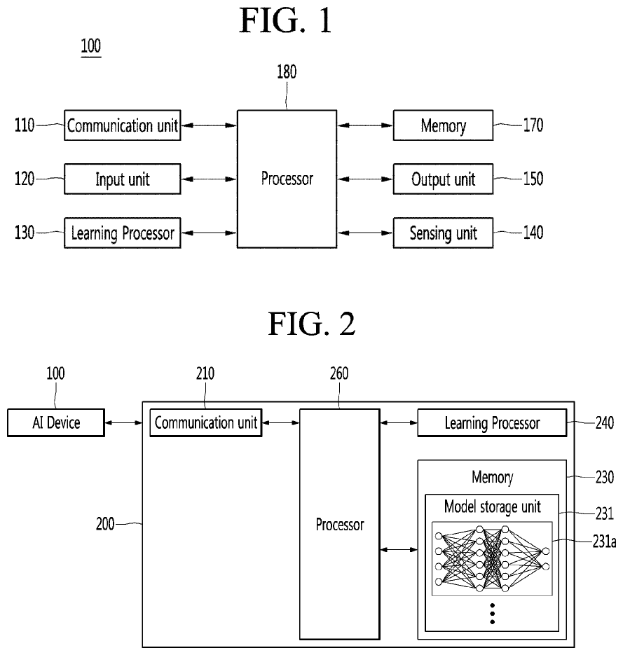

FIG. 1 illustrates an AI device including a robot according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server connected to a robot according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

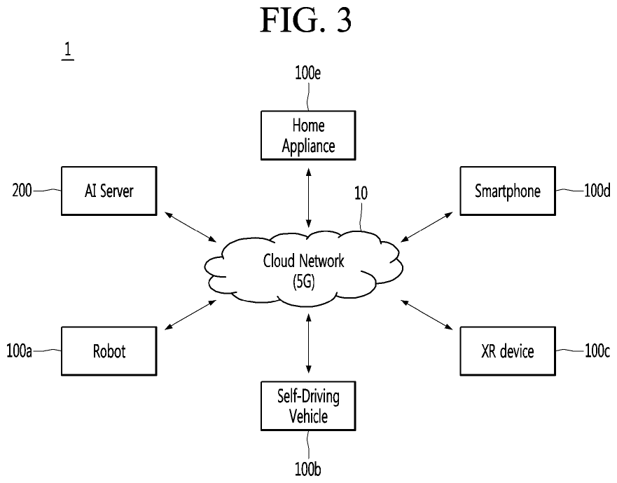

FIG. 3 illustrates an AI system including a robot according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

In the description below, the robot 100a may correspond to a stroller robot 1. Also, the input unit 120, the learning processor 130, and the sensing unit 140 may correspond to a detection unit 10.

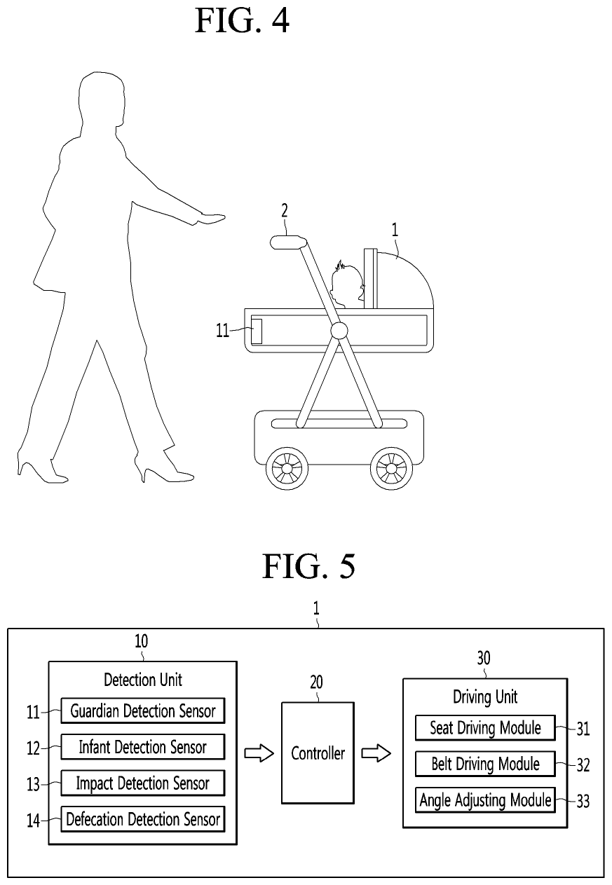

FIG. 4 is a diagram illustrating a stroller robot 1 together with a guardian according to an embodiment of the present invention.

Referring to FIG. 4, the stroller robot 1 may include a guardian detection sensor 11 on a front side, and may collect information about the body structure of the guardian or the distance between the stroller robot 1 and the guardian.

A camera acquires image data including the body structure of the guardian or the infant, and a microphone acquires voice data including the voice of the guardian.

A controller may acquire customer response data including at least one of the image data or the voice data through at least one of the camera or the microphone, may estimate the body structure from the acquired customer response data, and generate or update customer management information about the body structure of the guardian or the infant based on the estimated response.

According to the embodiment of the present invention, the stroller robot 1 may further include a memory that stores a learning model learned by a learning processor, and the controller may estimate the body structure from the customer response data through the learning model stored in the memory.

According to the embodiment of the present invention, the stroller robot 1 may further include a communication unit for connecting to a server, and the controller may control the communication unit to transmit the customer response data to the server and receive, from the server, Information about the body structure based on the customer response data.

The guardian detection sensor 11 may recognize a user's movement without installing a special interface device and may include an image processing method or device based on user's motion recognition.

According to the embodiment of the present invention, the guardian detection sensor 11 may be disposed on the front side of the stroller robot 1, but the guardian detection sensor 11 may be installed at the eye level of the guardian so as to scan the head of the guardian. The guardian detection sensor 11 may include a configuration that continuously acquires a body image including at least part of the body with an angle of view looking down by the image sensor to recognize the motion of the specific body part, and predicts the recognized motion of the body part.

A handle 2 is provided for determining whether the guardian is involved in the traveling of the stroller robot 1 and may be adjusted so as to be optimized to the position of the hand of the guardian. The handle 2 may include a fingerprint sensor or a heat sensor thereinside and may include any means for recognizing the body structure of the guardian.

FIG. 5 is a block diagram of the stroller robot 1 illustrated in FIG. 4.

Referring to FIG. 4, the user recognition-based stroller robot 1 according to the embodiment may include a detection unit 10, a controller 20, and a driving unit 30.

The detection unit 10 may recognize or measure at least one of the traveling state of the stroller robot 1 or the body structures of the infant inside the stroller robot 1 and the guardian outside the stroller robot 1. The detection unit 10 may include a guardian detection sensor 11, an infant detection sensor 12, an impact detection sensor 13, and a defecation detection sensor 14.

According to the embodiment of the present invention, as illustrated in FIG. 1, the guardian detection sensor 11 may be installed on the front side of the stroller robot 1. Although not illustrated, the infant detection sensor 12 may be installed above the infant and may be installed at any position where the infant can be recognized. Although not illustrated, the impact detection sensor 13 and the defecation detection sensor 14 ay be installed inside or outside the seat on which the infant is boarded and may be configured at optimal positions where impact and defecation can be detected.

The guardian detection sensor 11 may continuously collect the body image of the guardian and track the position of the specific body part.

The infant detection sensor 12 may continuously collect the body image of the infant and track the position of the specific body part.

As described above, the guardian detection sensor 11 and the infant detection sensor 12 may include a configuration that continuously scans the body structure of the target to acquire an image, recognizes the motion of the specific body part, and predicts the recognized motion of the body part.

The impact detection sensor 13 may be connected to the seat so as to detect a vibration or an impact amount appearing due to the movement of the infant. At least one impact detection sensor 13 may be installed inside or outside the seat.

The impact detection sensor 13 may record the strength and the time taken depending on the location of the vibration or impact, calculate an average value in real time, and perform comparison with a newly input vibration or impact amount to detect abnormal vibration or impact. The stroller robot 1 may further include a means for, in addition to the real-time average value calculation, setting a threshold value or a reference value and performing comparison with this value to detect abnormal symptoms.

The defecation detection sensor 14 may detect at least one of temperature, humidity, or specific chemical component of the seat. The defecation detection sensor 14 may detect whether the defecation has occurred by taking into account factors that change before and after the defecation. According to the embodiment of the present invention, an ammonia detection method may be used, and the temperature and the humidity that change depending on the urine or feces of the infant may be considered.

According to the embodiment of the present invention, the defecation detection sensor 14 may include, in addition to the impact detection sensor 13, any means for detecting the defecation.

The controller 20 may determine whether the stroller robot 1 is controlled according to the traveling state measured by the detection unit 10 and determine the structure change of the stroller robot 1 according to the body structure.

According to the embodiment of the present invention, the controller 20 may control the stroller robot 1 when the traveling state is a stopped state. Since the safety problem occurs when the structure is changed during traveling, it is automatically adjusted only when the traveling state is the stopped state. However, the present invention is not limited thereto, and it is also possible to perform setting vice versa.

According to the embodiment of the present invention, the controller 20 may control a braking signal to each driving module of the driving unit 30 so as to control the seat, the belt, the shake, or vibration of the stroller robot 1, the display angle adjustment, and the notification to the guardian.

The driving unit 30 may adjust at least one of the driving modules provided in the stroller robot 1 according to the determination of the controller 20.

The driving unit 30 may include a seat driving module 31, a belt driving module 32, an angle adjusting module 33, and a display module. The installation position of each module is not specified, and thus, although not illustrated in detail, each module may be disposed at an appropriate position according to the use environment.

The seat driving module 31 may adjust the position and height of the seat and may control the shake or vibration of the seat

The belt driving module 32 may adjust the strength of the belt installed on the seat according to the body structure of the infant. The belt driving module 32 may recognize the body structure of the infant and secure safety by adjusting the strength when the space between the belt and the body is loose.

The angle adjusting module 33 may adjust a screen angle of a display the infant views. According to the embodiment of the present invention, the display is limited to being viewed by the infant, but the guardian can also view the display, and a second display for the guardian can be additionally installed. At this time, the angle adjusting module 33 may further include a second angle adjusting module that adjusts the angle of the second display by recognizing the gaze of the guardian.

The angle adjusting module 33 may calculate the gaze direction of the infant recognized by the infant detection sensor 12 of the detection unit 10 and automatically adjust the display so that the front of the display can be fixed in the gaze direction of the infant.

The angle adjusting module 33 may adjust the angle based on the angle calculated by the controller 20, and the angle may be calculated by tracking the position of the eye in the body structure of the infant and calculating the position of the display.

The display module 34 may display the control state of the controller 20 on the display in the image form or may notify the user of the control state of the controller 20 in the voice form. As described above, the display is limited to being viewed by the infant, but a second display for the guardian may be also be installed and set to display the image. The display module 34 may be displayed by visualization or voice.

Hereinafter, a method for controlling the configuration of the user recognition-based stroller robot 1 will be described.

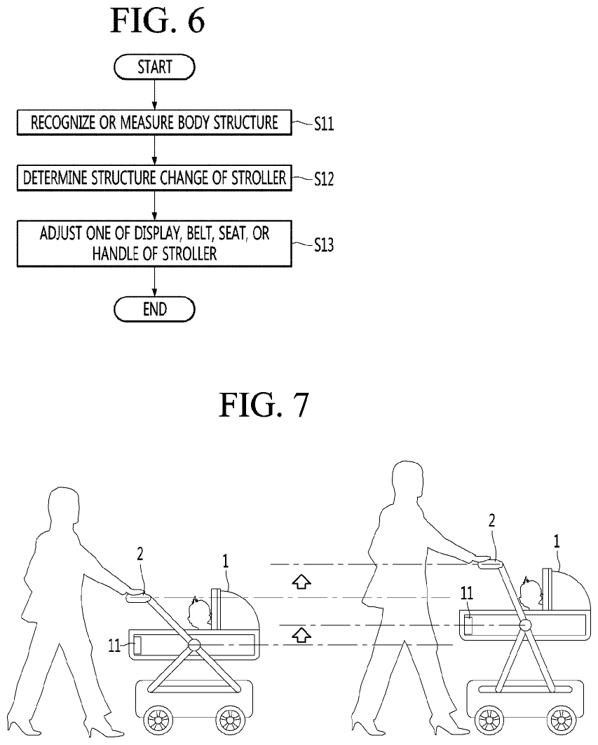

FIG. 6 is a flowchart of a method for controlling a stroller robot 1 according to the present invention.

Referring to FIG. 6, the control method for the user recognition-based stroller robot 1 may include: recognizing or measuring a traveling state of the stroller robot and body structures of an infant inside the stroller robot and a guardian outside the stroller robot 1 (S11); determining a structural change of the stroller robot according to the traveling state and the body structure (S12); and adjusting at least one of a display, a belt, a seat, or a handle 2 installed in the stroller robot 1 (S13).

In operation S11, the body structures of the guardian and the infant may be recognized or measured by the respective sensors. In operation S12, the controller 20 may determine the structure change of the stroller robot 1 and transmit a driving signal to the driving unit 30. In operation S13, the driving unit 30 may adjust at least one of the display, the belt, the seat, or the handle 2 installed in the stroller robot 1 through the respective driving modules.

FIG. 7 is a diagram illustrating a state in which the heights of the seat and the handle 2 of the stroller robot 1 are automatically adjusted according to an embodiment of the present invention.

Referring to FIG. 7, the handle 2 of the stroller robot 1 may be adjusted by recognizing a key of the guardian recognized by the guardian detection sensor 11.

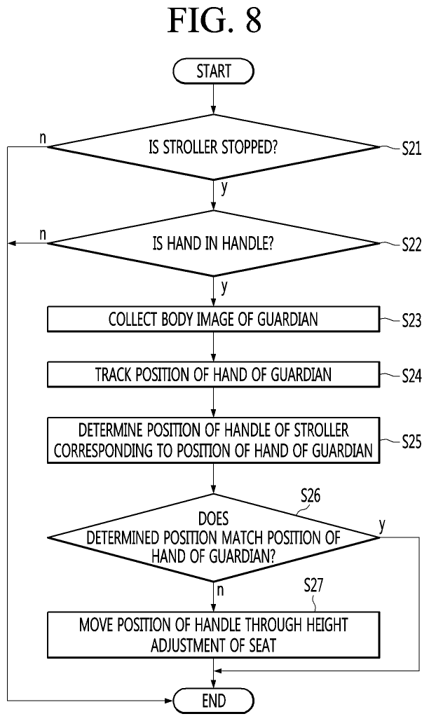

Specifically, the adjustment of the handle 2 of the stroller robot 1 is performed through the seat driving module 31 for adjusting the height of the seat. The process will be described later with reference to FIG. 8.

FIG. 8 is a flowchart illustrating the automatic adjustment of the position of the handle 2 during stop of the stroller robot 1 according to an embodiment of the present invention.

Referring to FIG. 8, the position of the handle 2 may be automatically changed only when the stroller robot 1 is stopped for the safety of the guardian and the infant.

According to the embodiment of the present invention, this process may include: determining whether the traveling state is a stopped state (S21); continuously collecting the body image of the guardian from the guardian detection sensor 11 mounted on the front of the stroller robot to track or measure the position of the hand (S23 to S26); and moving the handle 2 of the stroller robot to the position of the hand of the guardian (S27).

According to another embodiment of the present invention, this process may further include determining whether the hand of the guardian is in the handle 2 of the stroller robot 1 so that an operation is performed under the control of the guardian (S22).

According to operations S21 and S22 of the embodiment of the present invention, when the hand of the guardian is in the handle 2 of the stroller robot 1 while the stroller robot 1 is stopped, the body image of the guardian is collected (S23) and the position of the hand of the guardian is tracked (S24). The position of the handle 2 of the stroller robot 1 matching the position of the hand of the guardian is determined (S25), and it is determined whether the determined position and the position of the hand of the guardian coincide with each other (S26). When it does not coincide in operation S26, the seat driving module 31 may be driven to move the position of the handle 2 by adjusting the height of the seat (S27).

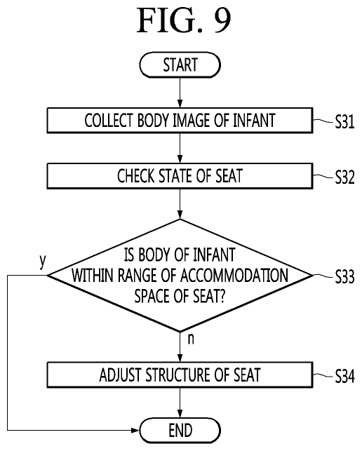

FIG. 9 illustrates a flowchart in which the position of the seat is automatically adjusted according to an embodiment of the present invention.

Referring to FIG. 9, the embodiment may include: recognizing the body structure of the infant (S31); checking the state of the seat (S32); measuring whether the body structure is within a range of an accommodation space (S33); and adjusting the structure of the seat so that the body structure of the infant matches the accommodation space of the seat (S34).

In operation S31, the body image of the infant may be collected through the infant detection sensor 12 to grasp the body structure of the infant, and the current state of the seat may be grasped (S32) to determine whether it is inconvenient or unsafe.

Operation S32 of checking the state of the seat is a process of determining whether the previously input state of the seat, such as the length of the seat, is appropriate for the body structure of the infant. Operation S32 of checking the state of the seat according to the embodiment of the present invention uses the accommodation space to determine whether the length of the seat accommodates the leg length of the infant (S33), but the present invention is not limited thereto. Operation S32 may include other factors that can comfort the body (back angle, head position, etc.).

For example, in the case where the toes exceed the seat when the infant straightens his/her feet, it may be determined as inappropriate. In this case, the structure of the seat may be adjusted (S34).

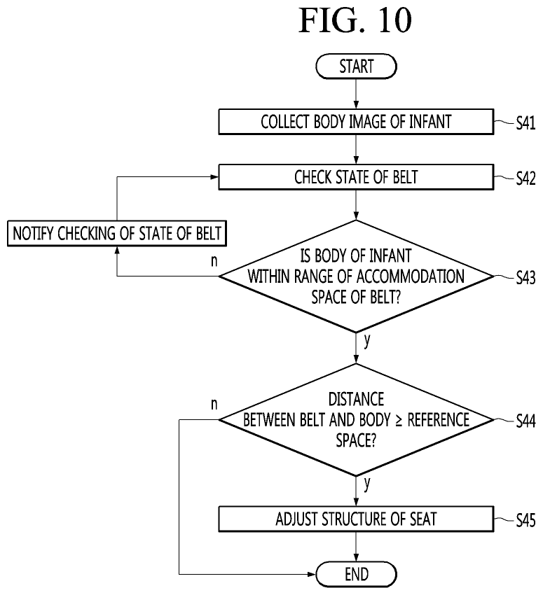

FIG. 10 illustrates a flowchart in which the structure of a belt is automatically adjusted according to an embodiment of the present invention.

Referring to FIG. 10, the adjustment of the belt structure may include recognizing the body structure of the infant (S41) and measuring whether the body structure is within a range of the accommodation space of the belt (S42 and S43). In the case, an alarm may be generated when the belt is not fastened.

In addition, the adjustment of the belt structure may include: determining whether the belt and the body are formed within a reference space where the safety of the infant is secured (S44); and adjusting the strength of the belt so that the body structure of the infant matches the accommodation space of the belt (S45).

The belt driving module 32 may adjust the strength of the belt installed in the seat. The body structure of the infant is recognized, and when the space between the belt and the body is loose, the strength may be controlled to secure safety.

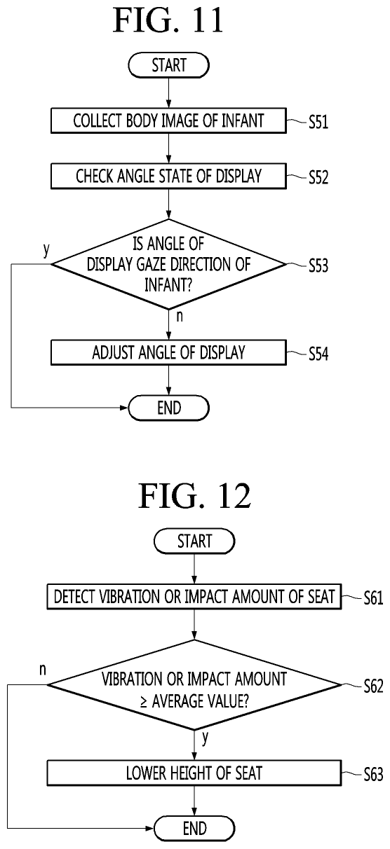

FIG. 11 illustrates a flowchart in which an angle of a display is automatically adjusted according to an embodiment of the present invention.

Referring to FIG. 11, the display angle adjustment may include: recognizing the body structure of the infant (S51); checking the current position and the angle state of the display (S52); and measuring whether the gaze of the infant is directed toward the display (S53).

The angle adjusting module 33 may calculate the gaze direction of the infant recognized by the infant detection sensor 12 of the detection unit 10 and automatically adjusting the display so that the front of the display is fixed in the gaze direction of the infant.

FIG. 12 illustrates a flowchart in which the height of the seat is automatically adjusted according to the vibration or the impulse of the seat, according to an embodiment of the present invention.

Referring to FIG. 12, the process of securing the stability by lowering the height of the seat when the activity of the infant is detected may include: detecting the vibration or the impact amount of the seat due to the movement of the infant (S61); determining whether the vibration or the impact amount of the seat exceeds an average value (S62); and lowering the height of the seat (S63).

In this case, the vibration or the impact amount may be detected through the impact detection sensor 13, and the abnormal situation may be determined by using at least one impact detection sensor 13. In addition, as described above, the abnormal situation may be determined by comparison with the reference value or the average value of data measured in real time.

According to another embodiment of the present invention, it is also possible to control the shake or vibration of the seat through the direct input of the guardian. For example, the guardian may control the shake or vibration of the seat by assuming the situation of sleeping or play.

This process may include: allowing the guardian to switch to a shake mode or a vibration mode including the strength and the cycle related to the shake or vibration of the sheet; and controlling the shake or vibration of the seat according to the switching to the shake mode or the vibration mode. In addition to automatic adjustment, the seat may be adjusted by manual input.

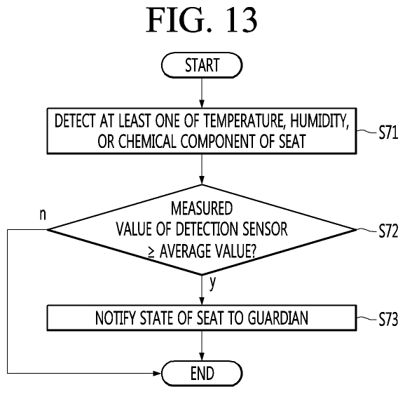

FIG. 13 illustrates a flowchart of the detection and notification of the defecation according to an embodiment of the present invention.

Referring to FIG. 13, the guardian may automatically receive an alarm about the detection of the defecation. This process may include: detecting at least one of temperature, humidity, or specific chemical component of the seat through the defecation detection sensor 14 installed in the seat (S71); determining whether the measured value of the defecation detection sensor 14 is different from the average value (S72); and notifying the guardian through the display module 34 (S73).

This may be detected through the defecation detection sensor 14. The defecation detection sensor 14 may detect at least one of the temperature, the humidity, or the specific chemical component of the seat, and the detection method is the same as the defecation detection sensor 14 described above.

In this case, the defecation detection sensor 14 may detect the defecation to determine the abnormal situation. The abnormal situation may be determined by comparison with the reference value or the average value of the data measured in real time.

When the measured value of the defecation detection sensor is maintained for a preset time, the method may further include notifying the guardian through the display module. In this case, since the state of the detection of the defecation continues even after a predetermined time elapses, it is possible to notify the guardian again of the diaper change and the like.

According to the present invention, each sensor of a detection unit is configured to thereby increase convenience during a guardian and an infant use a stroller robot.

According to the present invention, each driving module of a driving unit is configured to thereby automatically adjust the internal configuration of the stroller robot.

While the present invention has been particularly shown and described with reference to exemplary embodiments thereof, it will be understood by those skilled in the art that various changes in form and details may be made therein without departing from the spirit and scope of the invention as defined by the appended claims. Therefore, the scope of the present invention should not be limited to the above-described embodiments, but should be determined by all changes or modifications derived from the scope of the appended claims and equivalents of the following claims.

1. A user recognition-based stroller robot comprising:
a detection unit configured to recognize or measure at least one of a traveling state of the stroller robot or body structures of an infant inside the stroller robot and a guardian outside the stroller robot;
a controller configured to determine whether the stroller robot is controlled according to the traveling state measured by the detection unit and determine a structure change of the stroller robot according to the body structure of at least one of the infant or the guardian; and
a driving unit configured to adjust at least one of a display, a belt, a seat, or a handle installed in the stroller robot according to the determination of the controller.

2. The user recognition-based stroller robot according to claim 1, further comprising:
a camera configured to acquire image data including the body structure of the guardian or the infant; and
a microphone configured to acquire voice data including a voice of the guardian,
wherein the controller is configured to:
acquire customer response data including at least one of the image data or the voice data through at least one of the camera or the microphone;
estimate the body structure from the acquired customer response data; and
generate or update customer management information about the body structure of the guardian or the infant based on the estimated the body structure.

3. The user recognition-based stroller robot according to claim 2, further comprising:
a memory configured to store a learning model learned by a learning processor,
wherein the controller is configured to estimate the body structure from the customer response data through the learning model stored in the memory.

4. The user recognition-based stroller robot according to claim 2, further comprising:
a communication unit configured to connect to a server,
wherein the controller is configured to:
control the communication unit to transmit the customer response data to the server; and
receive, from the server, information about the body structure based on the customer response data.

5. The user recognition-based stroller robot according to claim 1, wherein the detection unit comprises:
a guardian detection sensor mounted on a front side of the stroller robot and configured to continuously collect a body image of the guardian and track a position of a specific body part; and
an infant detection sensor mounted on an upper portion of the stroller robot and configured to continuously collect a body image of the infant and track a position of a specific body part.

6. The user recognition-based stroller robot according to claim 5, wherein the detection unit further comprises:
an impact detection sensor connected to the seat and configured to detect a vibration or an impact amount appearing due to movement of the infant; and
a defecation detection sensor configured to detect at least one of temperature, humidity, or specific chemical component of the seat.

7. The user recognition-based stroller robot according to claim 1, wherein the driving unit comprises:
a seat driving module configured to adjust a position of the seat; and
a belt driving module configured to adjust strength of the belt installed in the seat according to the body structure of the infant.

8. The user recognition-based stroller robot according to claim 7, wherein the seat driving module is configured to control shake or vibration of the seat.

9. The user recognition-based stroller robot according to claim 7, wherein the driving unit further comprises an angle adjusting module configured to adjust a screen angle of the display by recognizing a gaze of the infant measured by the detection unit.

10. The user recognition-based stroller robot according to claim 7, wherein the driving unit further comprises an output module configured to display a control state of the controller on the display in an image form or notify a user of the control state of the controller in a voice form.

11. A method for controlling a user recognition-based stroller robot, the method comprising:
recognizing or measuring a traveling state of the stroller robot and body structures of an infant inside the stroller robot and a guardian outside the stroller robot;
determining a structure change of the stroller robot according to the traveling state and the body structures; and
adjusting at least one of a display, a belt, a seat, or a handle installed in the stroller robot.

12. The method according to claim 11, further comprising:
determining whether the traveling state is a stopped state;
continuously collecting the body image of the guardian through a guardian detection sensor mounted on a front side of the stroller robot to track or measure a position of a hand of the guardian; and
moving the handle of the stroller robot to the position of the hand of the guardian.

13. The method according to claim 12, further comprising determining whether the hand of the guardian is in the handle of the stroller robot.

14. The method according to claim 11, further comprising:
recognizing the body structure of the infant and measuring whether the body structure is within a range of an accommodation space of the seat; and
adjusting the structure of the seat so that the body structure of the infant matches the accommodation space of the seat.

15. The method according to claim 11, further comprising:
recognizing the body structure of the infant and measuring whether the body structure is within a range of an accommodation space of the belt;
determining whether the belt and the body are formed within a reference space where safety of the infant is secured; and
adjusting strength of the belt so that the body structure of the infant matches the accommodation space of the belt.

16. The method according to claim 11, further comprising:
recognizing the body structure of the infant and measuring whether a gaze of the infant is directed toward the display; and
adjusting a screen angle of the display.

17. The method according to claim 11, further comprising:
switching to a shake mode or a vibration mode including strength and a cycle related to the shake or vibration of the seat; and
controlling the shake or vibration of the seat according to the switching to the shake mode or the vibration mode

18. The method according to claim 11, further comprising:
detecting a vibration or an impact amount of the seat due to the movement of the infant;
determining whether the vibration or the impact amount of the seat exceeds an average value; and
lowering the height of the seat.

19. The method according to claim 11, further comprising:
detecting at least one of temperature, humidity, or specific chemical component of the seat through a defecation detection sensor installed in the seat;
determining whether the measured value of the defecation detection sensor is different from an average value; and
notifying the guardian through a display module.

20. The method according to claim 19, further comprising, when the measured value of the defecation detection sensor is maintained for a preset time, notifying the guardian through the display module.
